(19) United States
(12) Patent Application Publication
(10) Pub. No.: US 2008/0024895 A1
(43) Pub. Date: Jan. 31, 2008

(54) Method and Apparatus of Attachment of Information

(75) Inventors: Dahua He, Shanghai (CN); Yang Peng, Shanghai (CN); Sheng Jin, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/581,132

(22) PCT Filed: Nov. 29, 2004
(86) PCT No.: PCT/IB04/52582

§ 371 Date: Mar. 22, 2007

(30) Foreign Application Priority Data
Dec. 3, 2003 (CN) 200310122513.1

(51) Int. Cl. G11B 9/00

(52) U.S. Cl. 360/39

(57) ABSTRACT

The present invention provides a method and an apparatus for attaching information, which edits a parameter of the information to be attached and a parameter of the corresponding specific content into a synchronous playing file using a mark language. When played subsequently, the playing apparatus plays (HTMC, XML, SMIL) the attached information and the specific content according to the instructions from the synchronous playing file to realize the effect of synchronously multimedia playing the specific content and the attached information.

### BACKGROUND ART

The present invention relates to optical storage field, and more particularly to a method and apparatus for attaching information.

From CD, VCD, DVD to Blue-Ray disc, and from Read Only disc, Recordable Disc, Rewritable disc to Hybrid disc, optical storage technology presents a developing optical disc world having various formats and functions. In combination with the network technology, the optical storage technology can communicate the optical disc information with network information so that the optical disc becomes not only a huge information database but also a window of acquiring more information. Combined with multimedia technology, the optical storage technology can depict a virtual world that is more colorful than the real world.

Markup languages commonly used in the optical disc multimedia technology include HTML language (Hyper Text Markup Language), JavaScript language (JavaScript), XML (Extensible Markup Language), and so on. SMIL Language (Synchronized Multimedia Integration Language) is an application language of the XML language, it is recommended by the World Wide Web Consortium (W3C) and very suitable for exhibiting the rich and colorful characteristics of multimedia.

The development of network optical disc multimedia technology stimulates people's further and higher requirement of information communication manners. In addition to the contents stored in the optical disc, people expect to record on the discs the views and opinions about the contents of the discs, they also want to add a segment of anecdote or other interspersion information to the movie program or soccer game being played and add to a certain picture a commercial advertisement or a segment of voice or video of themselves, etc., and more importantly, people hope, during the subsequent optical disc playing, the added information can be played in a synchronous manner.

It is not difficult to manufacture an optical disc that synchronizes the added information with the corresponding specific content. People can edit all the contents and then store them in the optical disc. However, the case is different when information (for example, explanation, enhanced effect or advertisement and etc.) is added to the specific content stored on the disc, and when the added information is required to be played synchronously with the specific content during subsequent playing of optical disc; the specific content on the optical disc have already been stored in the optical disc, whereas the information to be added may be produced instantly, or may have been stored in another place, such as in the network or other storage media. It is sure that the effect of synchronous playing can also be realized if, according to the current process of manufacturing synchronous multimedia optical disc, the contents at different producing times, storage locations and formats are stored on the disc after being edited. However, if a user always wants to add some information to some content segments or scenes when playing the optical disc for each time, the user needs to re-edit and re-record all the contents on the disc for each time, no doubt the user will be troubled by this.

Therefore, it needs to provide a method and apparatus for attaching information to realize synchronous playing of the added information and the specific content.

### CONTENTS OF THE INVENTION

The present invention provides a method and apparatus for attaching information to overcome the disadvantages of the prior art.

The present invention provides a method for attaching information, comprising the steps of: acquiring a parameter of specific content in a pre-stored content; acquiring a parameter of the information to be attached, the information to be attached corresponding to the specific content; and editing the acquired parameter of the specific content and the acquired parameter of the information to be attached into a synchronous playing file.

The present invention provides a apparatus for attaching information, comprising: an acquiring device for acquiring a parameter of the information to be attached and a parameter of a specific content, wherein the information to be attached corresponds to the specific content; and an editing device for editing the acquired parameter of the information to be attached and the acquired parameter of the specific content into a synchronous playing file.

The method and apparatus for attaching information as provided by the present invention can make the attached information and the specific content be synchronously played in subsequent optical disc playing.

From the following description of the present invention made with reference to the accompanying drawings and the claims, other objects and achievements of the present invention will become obvious, and a comprehensive understanding of the invention can be obtained.

### DESCRIPTION OF FIGURES

Further explanation of the present invention is made in detail with reference to the accompanying drawings and embodiments.

FIG. 1 is a schematic diagram of attaching information to specific content in the optical disc;

FIG. 2 is a block diagram of an embodiment according to a apparatus for attaching information of the present invention; and

FIG. 3 is a flow chart of an embodiment according to a method for attaching information of the present invention.

The same reference signs represent the same, similar or corresponding features or functions throughout the above mentioned figures.

### MODE FOR CARRYING OUT THE INVENTION

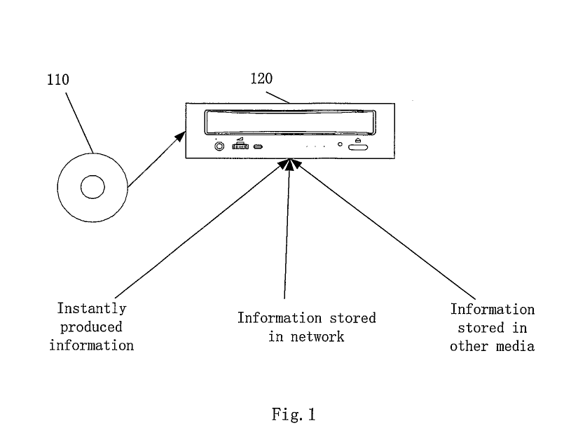

FIG. 1 is a schematic diagram of attaching information to specific content in the optical disc. As shown in FIG. 1, the optical disc playing device 120 can receive the instantly produced information during the process of playing optical disc 110, it can also receive information stored in the network and information stored in other media, all the information are those attached by the user to a specific scene or a specific segment of the optical disc contents.

Device 120 edits the parameters of the information attached by the user and the corresponding parameters of the specific content on corresponding optical disc into a synchronous playing file, the synchronous playing file can make the attached information and corresponding specific content be played synchronously.

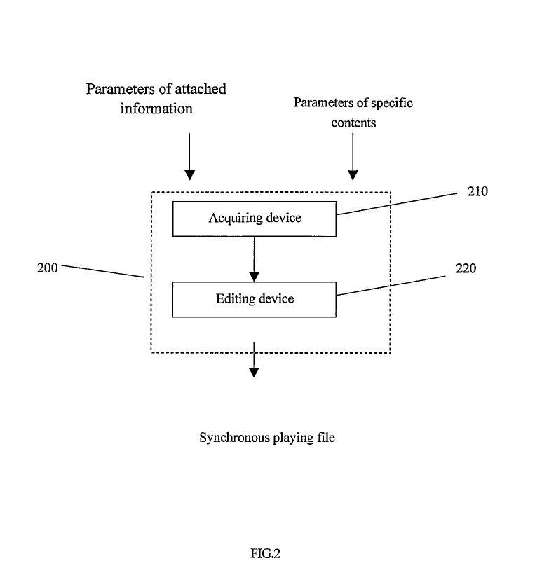

FIG. 2 is a block diagram of an embodiment according to a device 200 for attaching information of the present invention. Device 200 includes an acquiring device 210 for acquiring parameters which include not only the parameters of the information as attached by the user but also the parameters of the specific content of corresponding optical disc, for example, the time parameter, the address parameter, starting time, end time, data type, display effect parameter, etc. of the attached information. These parameters reflect the features like the relative time relation, location relation and relative display relation between the information attached by the user and the specific content of the corresponding optical disc.

Device 200 further includes an editing device 220 for editing the parameters acquired by the acquiring device 210 into a synchronous playing file by the use of a markup language, the adopted markup language is, for example, XML or SMIL, etc.. The synchronous playing file edited by the use of the markup language contains definite relative relations about the playing time and display effect of the corresponding specific content and the information attached by the user. Therefore, the information attached by the user and the specific content of the optical disc can be played synchronously via the synchronous playing file.

In the subsequent playing of the optical disc, the device for playing the optical disc first runs the synchronous playing file and plays the content of the optical disc and the information attached by the user according to the determined time and location relation following the instruction of the file to realize the effect of synchronous playing.

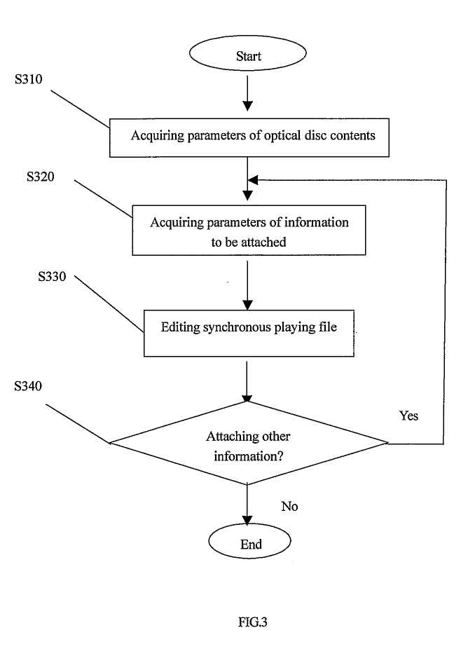

FIG. 3 is a flow chart of an embodiment according to a method for attaching information of the present invention. First, the parameters of the optical disc contents are acquired (step S310). Usually, in order to establish the synchronous relation between the attached information and the specific content of the optical disc, the parameters of the specific content in the optical disc, for example, address parameter, time parameter and so on are required, these parameters can be determined from the parameters of the optical disc contents. In normal case, the parameters of optical disc content are fixed and can be predetermined, for example the time of starting playing of the optical disc content can be set to zero, as a reference for other times.

Then, the parameters of the information attached by the user are acquired (step S320). During playing of the optical disc, the user attaches some information to the specific content of the disc, these information shall have corresponding parameters used for description, for example, an address parameter can describe the address of these information, a time parameter can describe the relative time relation between the time of attaching the information, the playing time and the specific content of the optical disc, and a display parameter can describe the display effect of these information. The above parameters can reflect the time, location and display relations between the information attached by the user and the corresponding specific content and information of the optical disc

Then, the acquired parameters are edited into a synchronous playing file (step S330). The method of editing the parameters into a synchronous playing file can be carried out according to the syntax of the markup language as adopted, the following specific embodiments are provided for further explanation.

After that, it is determined whether other information needs to be synchronously attached to the specific content of corresponding optical disc (stepS340), if so, repeating steps S320 and S330. Prior to attaching a piece of information, if there already exits a synchronous playing file, then corresponding parameters of the optical disc content shall have been edited into the file, whereas the parameters of each segment or scene (i.e. specific content) in the optical disc content can be relatively determined by the corresponding parameter, so it does not need to acquire the parameters of the optical disc content again. However, when first editing and producing the synchronous playing file, it needs to edit the optical disc contents into the synchronous playing file, so it needs to acquire the parameters of the optical disc contents.

The method provided by the present invention does not have limitation on the addresses of the information as attached and the edited synchronous playing file, so long as they can be conveniently invoked during subsequent playing of the optical disc, because in order to realize the synchronous playing effect, it needs to first play the synchronous playing file, and then to invoke the attached information to be played and corresponding optical disc content via the file.

It is very convenient to store the attached information and the synchronous playing file and the content of the optical disc on the same disc, but it may be subject to the limitation of whether the disc is writable and the storage space. It is also very convenient to store the attached information or synchronous playing file in the network, and a plurality of users can share the information via the network, for example, many people can communicate their opinions and comments on a soccer game and an advertising originality and a film cutting together.

The following is a SMIL synchronous playing file formed according to the method for attaching information of the present invention:

```
      <smil>
            <head>
                    <layout>
                          ... other layouts
                  <region id=”annotation” left=.. top=..height=..
                  width=... />
                  </layout>
            </head>
            <body>
                  <par>
                  <video id=”DVDMaster”
                  src=”../VIDEO_TS/title”.../>
                  <seq>
      <text id=”comment001” src=”c001.text”
region=”annotation” begin=”PAUSE1” dur=”PAUSE1_DUR”/>
      <img id=”comment002” src=”c002.png”
region=”annotation” begin=”PAUSE2” dur=”PAUSE2_DUR”/>
      <vedio id=”comment003” src=”c003.mpeg”
region=”annotation” begin=”PAUSE3” end=”PAUSE3_DUR”/>
      ...
      </seq>
      </par>
            </body>
      </smil>
```

Wherein DVDMaster is a parameter of the optical disc content for determining the optical disc content to be played; annotation is a position identification of the attached information for determining the display position of the attached information to be played; comment001 is an identification of the attached information which is a text information; comment002 is the identification of another attached information which is an image information; comment003 is the identification of the third attached information which is video information; PAUSE1 is the starting time of the attached information comment001; PAUSE1-DUR is the playing time of the attached information comment001; c001.text, c002.png and c003.mpeg are the content files of three attached information respectively.

Although the invention is described in combination with the embodiments, apparently various alternatives, modifications and changes that are made according to the contents as mentioned above are obvious to those skilled in the art, all these alternatives, modifications and changes shall fall into the scope of the spirit and the claims of the present invention.

What is claimed is:

1. A method for attaching information, comprising the steps of:
acquiring a parameter of a specific content in a pre-stored content;
acquiring a parameter of the information to be attached, said information to be attached corresponding to said specific content; and
editing the acquired parameter of said specific content and the acquired parameter of said information to be attached into a synchronous playing file.

2. The method according to claim 1, wherein said information to be attached comprises information provided by users.

3. The method according to claim 1, wherein said parameter comprises at least one of the two, a time parameter and an address parameter.

4. The method according to claim 3, wherein said time parameter comprises:
a relative time parameter which represents the relative time relation between said information to be attached and said specific content.

5. The method according to claim 1, wherein the parameter of said information to be attached comprises at least one of the two, a displaying effect parameter and a data type parameter.

6. The method according to claim 5, wherein said displaying effect parameter comprises a displaying location parameter.

7. The method according to claim 1, wherein said pre-stored content comprises a content stored in an optical disc.

8. The method according to claim 1, wherein said synchronous playing file comprises an extendable markup language (XML) file.

9. The method according to claim 1, wherein said synchronous playing file comprises a synchronous multimedia integrated language (SMIL) file.

10. A method for attaching information, comprising the steps of:
acquiring a parameter of the information to be attached, said information to be attached corresponding to a specific content in a pre-stored content; and
editing the acquired parameter of said information to be attached into a synchronous playing file which comprises the corresponding parameter of said specific content.

11. A apparatus for attaching information, comprising:
an acquiring device for acquiring a parameter of the information to be attached and a parameter of a specific content, wherein said information to be attached corresponds to said specific content; and
an editing device for editing the acquired parameter of said information to be attached and the acquired parameter of said specific content into a synchronous broadcasting file.

12. A apparatus according to claim 10, wherein said editing device comprises:
an extendable markup language (XML) file editing device.

13. A apparatus according to claim 10, wherein said editing device comprises:
an synchronous multimedia integrated language (SMIL) file editing device.

14. A apparatus according to claim 10, further comprising:
a playing device for playing said specific content and said attached information.
